(19) United States
(12) Patent Application Publication
(10) Pub. No.: US 2026/0258614 A1
(43) Pub. Date: Sep. 3, 2026

(54) DEVICE AND METHOD FOR APPLYING BINDER FOR SOIL STABILIZATION

(71) Applicant: Wirtgen GmbH, Windhagen (DE)

(72) Inventors: Christoph Menzenbach, Neustadt (DE); Axel Mühlhausen, Kassel (DE)

(21) Appl. No.: 19/541,678

(22) Filed: Feb. 17, 2026

(30) Foreign Application Priority Data
Feb. 20, 2025 (DE) 10 2025 106 577.2

(51) Int. Cl. E01C 21/00

(52) U.S. Cl. CPC E01C 21/00

(57) ABSTRACT

A device for applying binder for soil stabilization has a metering device including a data storage device for storing a layer thickness data set comprising layer thickness data. The layer thickness data in each case describe the layer thickness of a material layer applied to compacted soil, at a point in the terrain in a coordinate reference system independent of the device for applying the binder. A layer thickness data set can be read into the data storage device, which data set is then available for further data processing. The metering device also has a controller, configured such that the layer thickness data are read from the data storage device, and the metering device is controlled in such a way that a predetermined amount of binder is applied, depending on the layer thickness of the applied material layer. The disclosure also relates to a method for applying binder.

### BACKGROUND OF THE DISCLOSURE

### Field of the Disclosure

The disclosure relates to a device for applying binder for soil stabilization, which has a binder container for receiving binder, and a metering device with a metering element, the metering device having a control and/or computing device which is designed such that a predetermined amount of binder is applied with the metering element. Furthermore, the disclosure relates to a method for applying binder with a device for applying binder to an uncompacted material layer, which has been applied to compacted soil in a predetermined layer thickness using a self-propelled device for applying materials, in an operation preceding the application of binder, and which has been compacted using a self-propelled device for compacting soils, in an operation preceding the application of the uncompacted material layer.

### Description of the Prior Art

To improve or stabilize soils, it is known to introduce binders into the soil to enhance its workability and load-bearing capacity. Typical applications for soil stabilization include the creation of load-bearing soils for the construction of roads, squares or buildings.

The known soil stabilizers or recyclers have a collection container for a binder, for example lime or cement, and a spreading device for applying the binder to the soil, as well as a milling or mixing rotor with which the soil can be milled and the binder mixed into the soil immediately after application. In this case, generally a powdered binder is mixed into the soil. In addition to the stabilizers or recyclers, there are also construction machines known that can only apply the binder to the soil, but not mix it into the soil. These construction machines are also known as binder spreaders.

The self-propelled stabilizers or recyclers have a construction machine frame supported by a chassis with wheels, and a drive unit for the wheels, as well as a milling or mixing rotor. The known binder spreaders have a collection container and a spreading device for applying the binder to the soil. Both self-propelled and non-self-propelled binder spreaders are known. The non-self-propelled binder spreaders are attached to a towing vehicle, in particular a tractor, or towed by the tractor. Binder spreaders, stabilizers or recyclers have a control and/or computing device which is designed such that a predetermined amount of binder is applied, via the rotary valve.

A binder spreader is known from EP 2 216 444 A2. EP 1 012 396 B1 describes a stabilizer or recycler which has an integrated device for spreading powdered binder. The binder is provided in a funnel-shaped storage container, at the lower end of which a metering element is arranged. The metering element is a rotary valve, via which the binder can be dispensed in a metered manner.

In practice, leveling a terrain often requires applying several layers of materials in successive operations, the material layers being compacted after application in each case. This involves the use of a binder, which is mixed with the material applied in each case. The compaction of the materials is generally carried out with a road roller (roller) which has a roller drum for compacting materials. The material layers are applied, for example, using a grader, which has a blade for distributing and leveling materials. The binder is generally applied using a binder spreader. For example, in a preceding operation the previously applied material (soil) mixed with binder is compacted with a road roller. Material (soil) is then applied to the compacted soil using a grader, the soil being spread and leveled with the grader's blade. A predetermined amount of binder is then applied to the leveled soil using a binder spreader, which binder is mixed with the soil again by a subsequent stabilizer, and then compacted again with a road roller. This process can be repeated several times.

The amount of powdered or liquid binder for soil stabilization, which is applied to the soil using the device for applying binder, depends on a variety of factors, including primarily the nature of the soil and the layer thickness of the soil. An insufficient amount of binder results in inadequate load-bearing capacity of the soil. An excessive amount of binder, in turn, leads to higher costs and can also impair the load-bearing capacity.

The term GPS (Global Positioning System) is used to describe a position determination system that is based on the evaluation of the signal propagation times of signals from several satellites. The abbreviation GPS is used today colloquially, and sometimes even in technical language, as a generic term or pars pro toto for all satellite navigation systems, which are correctly subsumed under the abbreviation GNSS (Global Navigation (al) Satellite System) (Wikipedia: GPS). GNSS receivers for receiving satellite signals of a global navigation satellite system are already installed in many self-propelled construction machines.

### SUMMARY OF THE DISCLOSURE

The disclosure is based on the object of providing a device for applying binder for soil stabilization, which allows for optimization of the amount of binder applied. One object of the disclosure is also to provide a method for applying binder, with which the amount of binder applied can be optimized. Another object of the disclosure is to simplify the addition of a specific amount of binder.

These objects are achieved with the features of the independent claims. The subject matter of the dependent claims relates to preferred embodiments of the disclosure.

The embodiments of the disclosure described below can comprise one or more of the features or combinations of features mentioned below. A feature designated with an indefinite article can also be present more than once if the indefinite article is not to be understood with an explicit reference to a single use. A designation of features with a number word, for example, “first and second,” does not preclude the number of these features being greater than the number indicated by the number word. In the description of all the embodiments, the expression “can” is also to be understood as “preferably” or “expediently.”

One embodiment of the device according to the disclosure for applying binder for soil stabilization has a metering device which is characterized by a data storage device for storing a layer thickness data set comprising layer thickness data. The layer thickness data in each case describe the layer thickness of a material layer applied to compacted soil, at a point in the terrain in a coordinate reference system independent of the device for applying the binder. A layer thickness data set can be read into the data storage device via an interface, which data are then available for further data processing.

The metering device also has a control and/or computing device which is configured in such a way that the layer thickness data of the layer thickness data set are read out from the data storage device, and the metering element of the metering device is actuated during the advancement of the device for applying binder in such a way that, depending on the layer thickness of the applied material layer, a predetermined amount of binder is applied with the metering element. The control and/or computing device may also be referred to as a controller. Consequently, the amount of binder to be applied is adjusted to the layer thickness, a greater layer thickness requiring a greater amount of binder than a smaller layer thickness. In this case, it should be taken into account that the layer thickness of the applied layer can change continuously as the device for applying the binder is advanced. If the layer thickness decreases, the controller can reduce the amount of binder accordingly. If, however, the layer thickness increases, the controller can increase the amount of binder accordingly. The controller thus ensures that an optimal amount of binder is always metered, even when the layer thickness changes. This ensures sufficient load-bearing capacity of the soil with minimal consumption of binder. However, other factors can also be taken into account when controlling the amount of binder, in particular the nature of the soil. Regardless of the nature of the soil, a thicker layer will, however, always require a larger amount of binder.

The controller and/or the data storage device can be part of a central controller of the device for applying binder or of a central storage device, or parts of the controller and/or of the data storage device can be part of a central controller of the device for dispensing binder or of a central storage device.

The device according to the disclosure for applying binder can include a construction machine positioning device which is configured to generate construction machine position data describing the position of a construction machine reference point, which is assigned to the device for applying binder, in the coordinate reference system independent of the device for applying binder. This reference point can be a point located on the construction machine that describes the location of the construction machine in the coordinate reference system. The reference point can be located, for example, at the outlet of the metering device.

The controller can be configured such that, based on the layer thickness data and the construction machine position data, the layer thickness of the applied layer is determined at the current position of the construction machine, and the metering element of the metering device is actuated, during the advancement of the device for applying binder, in such a way that an amount of binder that correlates (positively) with the layer thickness is applied with the metering element. The layer thickness data describe the layer thickness at a specific location in the terrain, while the construction machine position data describe the position of the device for applying binder in the terrain. Since the device for applying binder has both the layer thickness data and the position data available, an amount of binder correlating with the layer thickness can be continuously applied during the advancement of the device for applying binder, depending on its current position. In this case, the amount of binder can be regulated continuously or in specific steps, for example depending on a distance traveled or a period of time.

The interface for receiving the layer thickness data set can be a cloud interface for reading out the layer thickness data set from the data storage device of a computer cloud, or an interface for reading out data from the data storage device of a computer in a local network. However, the data can also be read into the data storage device via any other interface, for example a USB interface from a USB storage device. In this case, it is irrelevant how the layer thickness data set is generated. Crucially, however, the layer thickness data set must contain all the information needed to specify the layer thickness at different locations in the terrain.

In a further embodiment of the device according to the disclosure for applying binder, the metering device has a data storage device for storing a first elevation profile data set, which comprises first elevation profile data which in each case describe the elevation of soil, compacted in a preceding operation with a soil compaction device, at a point in the terrain in a coordinate reference system independent of the device for applying binder, and a second elevation profile data set, which comprises second elevation profile data which in each case describe the elevation of a material layer applied to the compacted soil, in an operation following the preceding operation with a material application device, at a point in the terrain in the coordinate reference system independent of the device for applying binder.

The controller is configured such that the first and second elevation profile data sets are read out from the data storage device, and layer thickness data are generated based on the elevation information of the first elevation profile data and the second elevation profile data, which layer thickness data in each case describe the layer thickness of the material layer applied to a compacted soil at a point in the terrain in the coordinate reference system independent of the device for applying binder. The layer thickness data can then be stored again in a storage device. The layer thickness data can be continuously generated during the advancement of the device for applying binder. However, it is also possible to generate a layer thickness data set in advance, based on the elevation information from the elevation profile data and the second elevation profile data, which then can be read out of the storage device in succession during advancement of the device for applying binder.

The controller is further configured in such a way that the layer thickness data of the layer thickness data set are read out from the storage device and the metering element of the metering device is actuated in such a way that, during advancement of the device for application, a predetermined amount of binder is applied with the metering element, depending on the layer thickness of the applied material layer.

The controller can be configured such that the layer thickness data are determined in each case from the first and second elevation profile data sets, based on the calculation of the difference between the elevation of the layer applied to the compacted soil and the elevation of the compacted layer in the terrain. If a uniform coordinate reference system is provided on the construction site for all construction machines, which is the case in practice, the layer thickness can easily be determined from the available data.

In this embodiment, the device for applying binder can have a construction machine positioning device which is configured to generate construction machinery position data describing the position of a construction machine reference point, assigned to the device for applying binder, in a coordinate reference system independent of the device for applying binder. The controller can be configured in such a way that, based on the layer thickness data and the construction machine position data, the layer thickness of the applied layer is determined and the metering element of the metering device is actuated, during the advancement of the device for applying binder, in such a way that an amount of binder correlating with the layer thickness is applied with the metering element.

A special aspect of the disclosure lies in determining the layer thickness in order to generate the layer thickness data. It is advantageous that the first and second elevation profile data can be determined by the construction machines themselves in the joint work process involving a plurality of construction machines. The layer thickness can then be determined from the first and second elevation profile data. Therefore, measuring the layer thickness outside of this work process is not necessary, which simplifies the entire work process.

The metering device may include an interface for receiving the first and second elevation profile data sets, in particular a cloud interface for reading out the first and second elevation profile data sets from a data storage device in a computer cloud. Consequently, the first and second elevation profile data, which were recorded with the other construction machines involved in the work process, can be read into the data storage device of the computer cloud and read out from the data storage device of the computer cloud by the metering device of the device for applying binder. The calculation of the layer thickness can then take place on the device for applying the binder, but also in the computer cloud.

Another alternative embodiment provides for the acquisition of only the first elevation profile data from a different construction machine involved in the work process. The second elevation profile data are recorded by the device for applying binder itself. In this embodiment, the device for applying binder has an elevation position determination device which is configured to generate elevation position data describing the position of an elevation reference point assigned to the device for applying binder, in a coordinate reference system independent of the device for applying binder. The metering device has a data storage device for storing a first elevation profile data set, which includes first elevation profile data that in each case describe the elevation of soil compacted in a preceding operation with a soil compaction device, at a point in the terrain in a coordinate reference system independent of the device for applying binder.

The controller is configured such that, based on the elevation position data of the elevation position determination device, second elevation profile data are generated, which in each case describe the elevation of a material layer applied to the compacted soil, in an operation following the preceding operation, with a material application device, at a point in the terrain in the coordinate reference system independent of the device for applying binder. Consequently, the second elevation profile data can be generated using the elevation position determination device, which is part of the device for applying binder.

The controller is configured such that the first elevation profile data set is read from the data storage device, and layer thickness data are generated based on the elevation information of the first elevation profile data and the second elevation profile data, which layer thickness data in each case describe the layer thickness of the material layer applied to the compacted soil, at a point in the terrain in the coordinate reference system independent of the device for applying binder.

The controller is further configured in such a way that the metering element of the metering device is actuated in such a way that, during advancement of the device for applying binder, a predetermined amount of binder is applied with the metering element, depending on the layer thickness of the applied material layer.

In principle, in this case, a layer thickness data set (for later use, in particular for construction site documentation) can then also be generated from the individual layer thickness data.

The device for applying binder may include a construction machine positioning device, which is configured to generate construction machine position data describing the position of a construction machine reference point assigned to the device for applying binder, in a coordinate reference system independent of the device for applying binder, and the controller may be configured such that, based on the layer thickness data and the construction machine position data generated by the construction machine position determination device, the layer thickness of the applied layer is continuously determined during the advancement of the device for applying binder, and the metering element of the metering device is actuated such that an amount of binder correlating with the layer thickness is applied by the metering element.

In this embodiment, the metering device only needs to include one interface for receiving the first elevation profile data set, in particular a cloud interface for reading out the first elevation profile data set from a data storage device of a computer cloud, since the second elevation profile data are generated on the device for applying the binder itself.

The elevation position determination device and the construction machine position determination device can be two separate devices or a common device, which determine the position of two different reference points, one reference point indicating the elevation of the material layer on which the device for applying binder moves in the terrain, and the other reference point indicating the position at which the device for applying binder is currently located, in particular the position at which the binder is applied, for example the position of the outlet of the metering element. However, the first and second reference points do not need to be different points if a common reference point can be found, for example the position of the outlet of the metering element.

The unified coordinate reference system can be any coordinate system, for example a geodetic coordinate system. The elevation position determination device and the construction machine position determination device may include at least one GNSS receiver for receiving satellite signals from a global satellite system. Such systems are part of the general prior art and are usually already installed in known construction machines.

The disclosure also relates to a method for applying a binder using a device for applying binder to an uncompacted material layer which was applied, in an operation preceding the operation of applying binder, to compacted soil using a self-propelled material application device, which soil, in an operation preceding the operation of applying the uncompacted material, was compacted using a self-propelled soil compaction device, a surveying system being provided which is designed such that the position of a reference point related to the soil compaction device and the position of a reference point related to the material application device or the device for applying binder can be determined in a coordinate system.

The method according to the disclosure for applying binder comprises the following method steps:
determining the elevation position of the reference point related to the soil compaction device using the surveying system during soil compaction with the soil compaction device, and
determining the elevation position of the reference point related to the material application device using the surveying system during the application of materials with the material application device, or determining the elevation position of the reference point related to the device for applying binder using the surveying system during the binder application with the device for applying binder,
determining the layer thickness of the applied material layer from the difference between the elevation position of the reference point related to the material application device and the elevation position of the reference point related to the soil compaction device, or from the difference between the elevation position of the reference point related to the device for applying binder and the elevation position of the reference point related to the soil compaction device, and applying a predetermined amount of binder to the uncompacted material layer during the advancement of the device for applying binder, using a metering device provided on the device for applying binder, depending on the determined layer thickness of the applied material layer.

The device for applying binder can be a binder spreader with a machine frame supported on wheels or a soil stabilizer or recycler with a machine frame supported on wheels, it being possible for the reference point of the elevation position determination device to be at the height of the contact surface of the wheels. Binder spreaders, soil stabilizers, or recyclers can, however, in principle also have tracked undercarriages instead of wheels, the reference point then being at the height of the contact surface of the tracked undercarriage.

The device for compacting soils can be a road roller with a machine frame supported by wheels and a roller drum, it being possible for the reference point of the elevation position determination device to be at the height of the contact surface of the wheels or the roller drum.

The device for applying materials can be a grader with a machine frame supported by wheels or, in principle, also by tracked undercarriages, on which a blade for distributing and leveling materials is provided, it being possible for the reference point of the elevation position determination device to be at the height of the lower edge of the blade.

### BRIEF DESCRIPTION OF THE DRAWINGS

A plurality of exemplary embodiments of the device and method according to the disclosure are explained in more detail below with reference to the figures, in which:

FIG. 1A is a simplified schematic view of a road roller for compacting a material layer applied to soil and mixed with binder, the road roller being in a first position,

FIG. 1B shows the road roller of FIG. 1, the road roller being in a second position,

FIG. 2A is a simplified schematic view of a grader for applying and distributing materials on the material layer compacted by the road roller, the grader being in a first position,

FIG. 2B shows the grader of FIG. 2, the grader being in a second position,

FIG. 3A to 3F show a binder spreader when driving over the material layer applied and distributed by the grader, the binder spreader applying a predetermined amount of binder depending on the layer thickness of the material layer,

FIG. 4 is a schematic view of a binder spreader, a computer cloud, the satellites of a global satellite system and an external computing unit for illustrating a first exemplary embodiment of the device for applying binder,

FIG. 5 is a schematic view of a binder spreader, a computer cloud, the satellites of a global satellite system and an external computing unit for illustrating a second exemplary embodiment of the device for applying binder,

FIG. 6 is a schematic view of a binder spreader, a computer cloud, the satellites of a global satellite system, a grader and a road roller for illustrating a third exemplary embodiment of the device for applying binder,

FIG. 7 is a schematic view of a binder spreader, a computer cloud, the satellites of a global satellite system and a road roller for illustrating a fourth exemplary embodiment of the device for applying binder, and

FIG. 8 is a simplified schematic view of a recycler or stabilizer.

### DETAILED DESCRIPTION

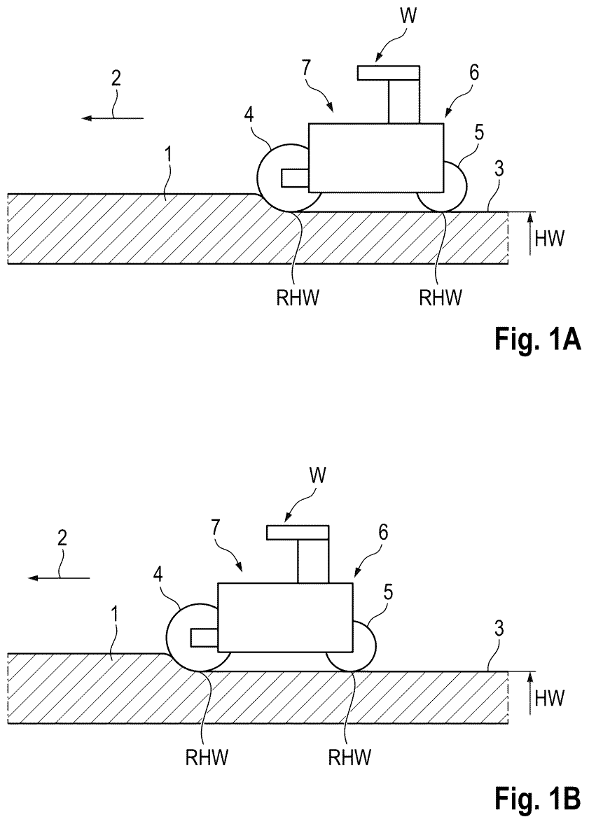

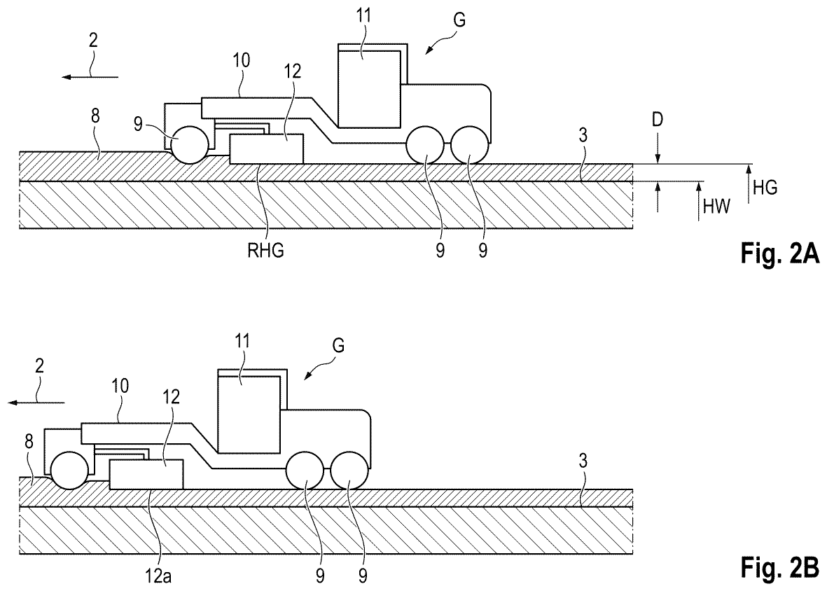

FIGS. 1A and 1B show a simplified schematic representation of a device for compacting material W when driving over a material layer, which was previously applied to soil and mixed with binder and which has been largely leveled. The material 1 applied to the soil and mixed with binder can be seen on the left-hand side in FIGS. 1A and 1B. The device for compacting material W moves in working direction 2 from right to left, thereby compacting the material 1. The compacted soil 3 has an elevation designated HW. In the present exemplary embodiment, it is assumed for simplification in the drawing that the compacted soil 3 has a flat surface.

In the present exemplary embodiment, the device for compacting material W is a conventional road roller, also referred to as a roller. The road roller W has a machine frame 6 supported by a front roller band 4 in the working direction 2 and rear wheels 5, with a working platform 7.

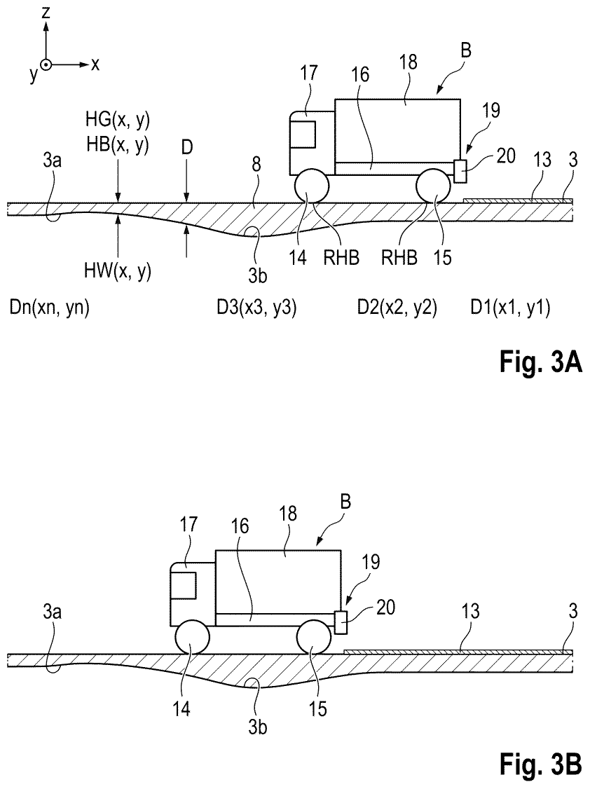

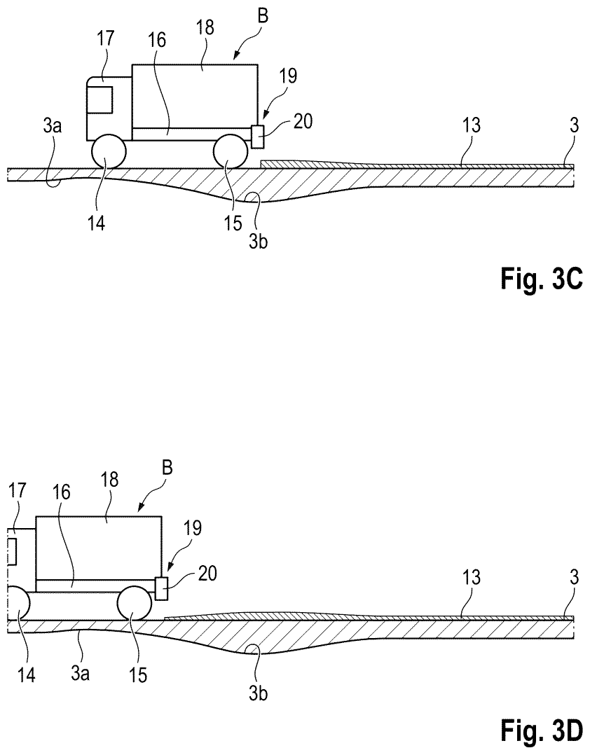

FIGS. 2A and 2B illustrate a further operation in which material 8 is applied to the compacted soil 3 (FIGS. 1A and 1B) using a device for applying materials G. The mutually corresponding parts in the figures are again provided with the same reference signs. In the present exemplary embodiment, the device for applying materials G is a self-propelled construction machine for producing large, flat surfaces, which is also referred to as a grader or leveler. The grader G has a machine frame 10 supported in the working direction 2 by front and rear wheels 9, with a working platform 11. The grader G has a movable blade 12 for distributing and leveling the material. The uncompacted material 8 applied to the compacted soil 3 is shown simplified in FIGS. 2A and 2B as a material layer 8 with a constant layer thickness.

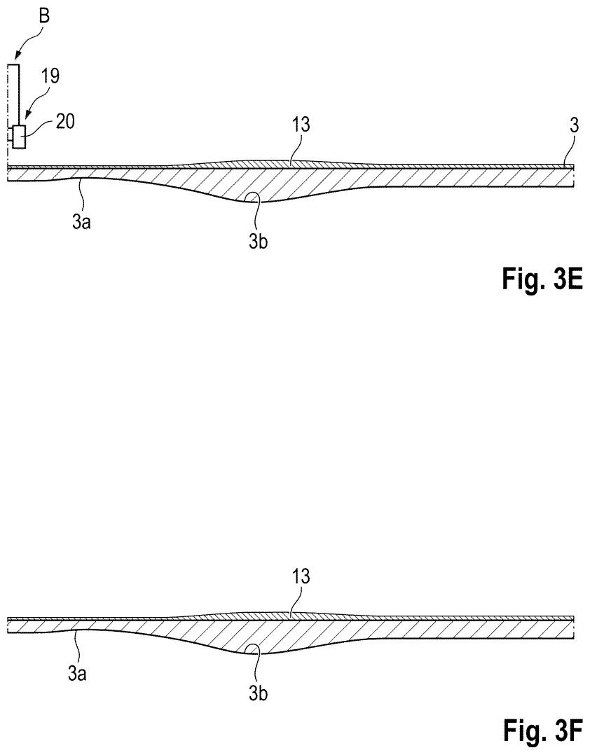

FIG. 3A to 3F illustrate a further operation in which a predetermined amount of binder 13 is applied to the uncompacted material layer 8 (FIGS. 2A and 2B) using a device for applying binder B. The device for applying binder B may also be referred to as an apparatus for applying binder B. The mutually corresponding parts in the figures are again provided with the same reference signs. The binder 13 is later mixed with the uncompacted material 8 and compacted, but this is not shown in the figures. A further material layer can then be applied on the compacted soil using a material application device, a predetermined amount of binder can be applied on the uncompacted material layer using a device for applying binder, and the binder can then be mixed with the material again and compacted using a material compaction device.

FIG. 3A to 3F illustrate, in an exaggerated representation that is not to scale, that the compacted soil 3, onto which the material layer 8 has been applied, which is shown flat in FIGS. 1A and 1B and FIGS. 2A and 2B, can in practice exhibit elevations 3a and depressions 3b. It is also possible that the material layer 8 may be applied unevenly. Both of these factors lead to variations in the thickness of material layer 8, which must be taken into account when applying binder.

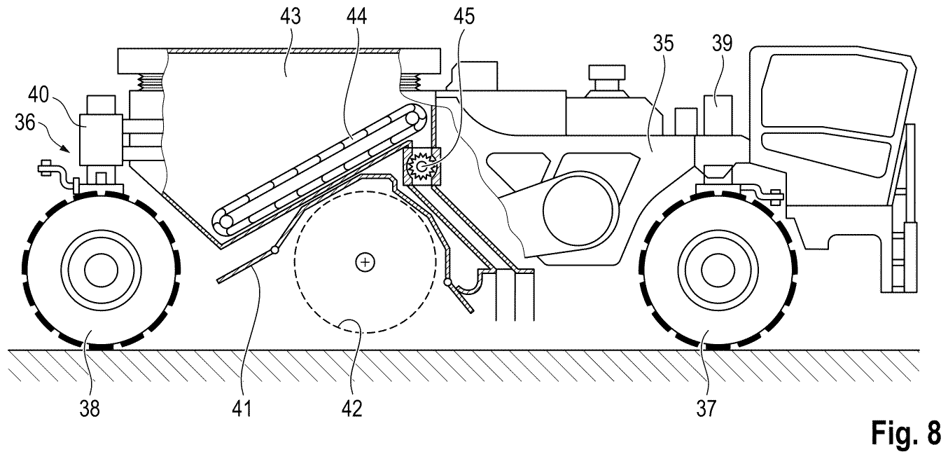

In the present exemplary embodiment, the device for applying binder B for soil stabilization is a binder spreader which has a machine frame 16 that is supported by front and rear wheels 14, 15 and has a driver's cab 17. The device for applying binder B can, however, also be part of a recycler or stabilizer, in which a device for applying powdered binder (binder spreader) or for applying liquid binders is integrated. Therefore, a recycler or stabilizer can also function as a device for applying binder. The use of a recycler or stabilizer has the advantage that binder can be mixed into the soil immediately after application. This can, for example, reduce or completely prevent the binder from being blown away by wind. An exemplary embodiment of a recycler or stabilizer will be described below with reference to FIG. 8.

The binder spreader B has a binder container 18 for receiving binder, and a metering device 19 with a metering element 20. In the present exemplary embodiment, the metering element 20 is located on the rear part of the machine frame 16 and extends over the entire working width of the binder spreader.

FIGS. 1A and 1B, 2A and 2B and 3A to 3F show that in the entire work process a device for compacting materials W, in particular a road roller, a device for applying materials G, in particular a grader G, and a device for applying binder B, in particular a binder spreader or recycler or stabilizer, is used.

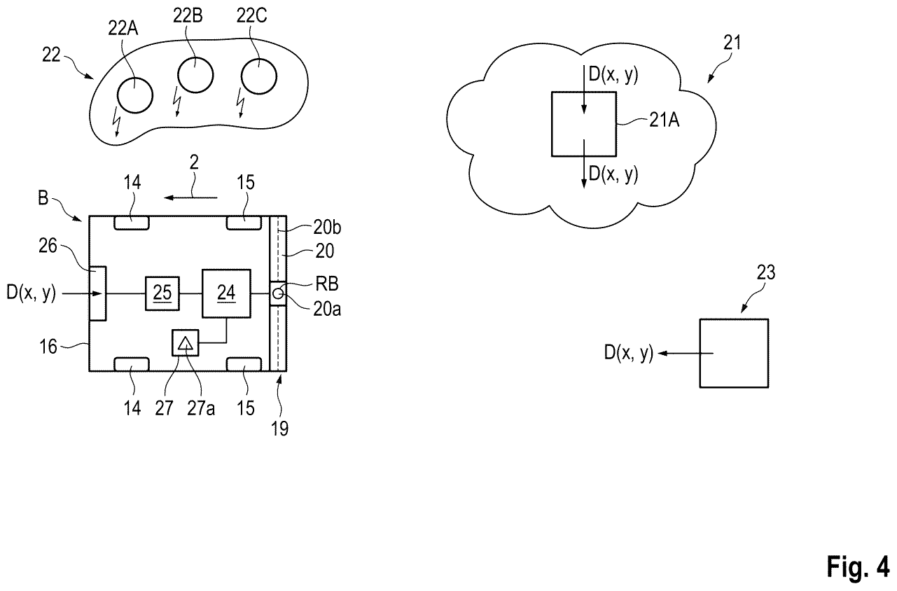

A first exemplary embodiment of the device for applying binder B is described below with reference to FIG. 4. The mutually corresponding parts in the figures are again provided with the same reference signs. FIG. 4 shows, to illustrate the entire work process, a binder spreader B, a computer cloud 21, the satellites 22A, 22B, 22C of a global satellite navigation system 22, and an external data processing facility 23, in a highly simplified schematic representation. FIG. 4 shows the machine frame 16 of the binder spreader B, which is supported by wheels 14, 15. The binder spreader B has a metering device 19, which includes a controller 24, a data storage device 25, an interface 26, and a metering element 20 extending over the working width of the binder spreader on the rear part of the machine frame 16.

A controller 24 is understood to be a device which is designed in such a way that the actions required for the operation of the metering device are carried out. The controller can have, for example, a general processor, a digital signal processor (DSP) for continuously processing digital signals, a microprocessor, an application-specific integrated circuit (ASIC), a field-programmable gate array (FPGA), or other integrated circuits (IC) or hardware components. A data processing program (software) can run on the hardware components. A combination of the various components is also possible. The controller 24 can be part of a central controller of the binder spreader, or parts of the controller can be part of a central controller of the binder spreader, which can perform further actions.

In the present exemplary embodiment, the interface 26 is a cloud interface for reading out a layer thickness data set D(x, y) from a data storage device 21A of the computer cloud 21. A data processing device 23, which is available in a planning office, can in turn exchange data with the computer cloud 21, so that the layer thickness data set D(x, y) can be created in the planning office and uploaded to the computer cloud. The interface can also be configured for direct communication with interfaces of other devices, e.g. with the data processing device 23. A cloud interface can then be dispensed with.

The layer thickness data set D(x, y) includes layer thickness data D1(x1, y1), D2(x2, y2), D3(x3, y3), . . . , Dn(xn, yn) which in each case describe the layer thickness D of a material layer 8 applied to compacted soil 3 at a point in the terrain in a coordinate reference system (x, y) independent of the device for applying binder B. The coordinate reference system (x, y) can be a geodetic coordinate system of a global satellite navigation system, which may include a plurality of satellites. For better illustration, the position of a point at which the material layer 8 has a certain layer thickness D is specified in the exemplary embodiment not by latitude and longitude, but rather by the coordinates (x, y) in a Cartesian coordinate system (x, y, z).

In addition, the binder spreader B has a construction machine position determination device 27, which is designed to generate construction machine position data which in each case describe the position of a construction machine reference point RB assigned to the metering element 20, in the coordinate reference system. The construction machine position determination device 27 has a GNSS receiver 27a for receiving satellite signals of the global satellite navigation system 22. It is sufficient for the construction machine position data to describe the position of the reference point RB on the terrain surface. Elevation information is not required. In the present exemplary embodiment, the construction machine reference point RB is located at the outlet 20a of the metering element 20, preferably centrally on the axis 20b extending transversely to the advancement direction of the binder spreader, along which the binder is applied by the metering element 20.

The controller 24 is configured such that the layer thickness data of the layer thickness data set D1(x1, y1), D2(x2, y2), D3(x3, y3), . . . , Dn(xn, yn) downloaded from the computer cloud 21 via the interface 26 are read out from the data storage device 25. The controller 24 receives not only the layer thickness data, but rather also the construction machine position data from the construction machine position determination device 27. Based on the layer thickness data, which specify the layer thickness at a point in the terrain, and the construction machine position data, which specify the location where the outlet of the metering element 20 is currently located, the controller 24 continuously determines the layer thickness D of the applied layer during the advancement of the binder spreader B and controls the metering device 20 in such a way that an amount of binder correlating to the layer thickness D is applied.

For measuring the amount of binder, the controller 24 can use a suitable algorithm which measures an increasing amount of binder with increasing layer thickness, the amount of binder applied per unit of time also depending on the advancement rate of the binder spreader B. Other factors, in particular the nature of the soil, can also be taken into account when measuring the amount of binder required.

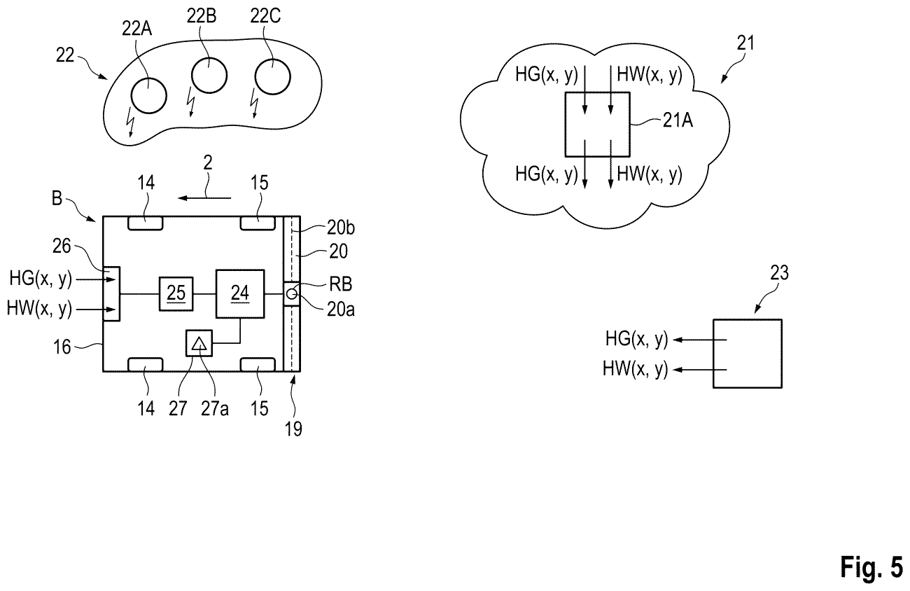

FIG. 5 illustrates a further exemplary embodiment of the binder spreader B, which differs from the exemplary embodiment described with reference to FIG. 4 in that the binder spreader is provided not with a layer thickness data set, but rather with a first elevation profile data set HW1(x1, y1), HW2(x2, y2), HW3(x3, y3), . . . , HWn(xn, yn) and a second elevation profile data set HG1(x1, y1), HG2(x2, y2), HG3(x3, y3), . . . , HGn(xn, yn). In the present exemplary embodiment, the first and second elevation profile data sets are uploaded from the data processing device 23 of the planning office to the computer cloud 21, and downloaded from the computer cloud via the cloud interface 26 and stored in the storage device 25 of the binder spreader B. In principle, the interface 26 can also be configured to receive the first elevation profile data set HW and the second elevation profile data set HG from different sources. In particular, the interface 26 can be configured to communicate directly with the device for compacting material W and the device for applying material G, and to receive the first and second elevation profile data sets directly from these devices.

The first elevation profile data set HW(x, y) comprises elevation profile data HW1(x1, y1), HW2(x2, y2), HW3(x3, y3), . . . , HWn(xn, yn) which in each case describe the elevation of the soil 3, compacted in a previous operation with the road roller W, at a point in the terrain in the coordinate reference system (x, y) independent of the binder spreader B, and the second elevation profile data set HG(x, y) comprises elevation profile data HG1(x1, y1), HG2(x2, y2), HG3(x3, y3), . . . , HGn(xn, yn) which in each case describe the elevation of the material layer 8, applied in an operation following the preceding operation with the grader G, at a point in the terrain in the coordinate reference system (x, y) independent of the binder spreader B.

In the second exemplary embodiment, the controller 24 is configured such that the first elevation profile data set HW1(x1, y1), HW2(x2, y2), HW3(x3, y3), . . . , HWn(xn, yn) and the second elevation profile data set HG1(x1, y1), HG2(x2, y2), HG3(x3, y3), . . . , HGn(xn, yn) are read out from the data storage device 25, and layer thickness data D1(x1, y1), D2(x2, y2), D3(x3, y3), . . . , Dn(xn, yn) are generated on the basis of the elevation information of the first elevation profile data and the second elevation profile data. As in the first exemplary embodiment, the metering element 20 is controlled by the controller 24 in such a way that a predetermined amount of binder is applied by the metering element, depending on the layer thickness D of the applied material layer 8.

The controller 24 calculates the layer thickness data in each case by calculating the difference D(x, y)=HG(x, y)−HW(x, y) between the elevation HG(x, y) of the layer 8 applied to the compacted soil 2 with the grader G, previously determined at a specific point, and the elevation HW(x, y) of the soil 2 compacted with the road roller W in the terrain, previously determined at a specific point.

$$D 1 ( x , y ) = HG 1 ( x , y ) - HW 1 ( x , y )$$

$$D 2 ( x , y ) = HG 2 ( x , y ) - HW 2 ( x , y )$$

$$D 3 ( x , y ) = HG 3 ( x , y ) - HW 3 ( x , y )$$

$$D 4 ( x , y ) = HG 4 ( x , y ) - HW 4 ( x , y )$$

$$…$$

$$Dn ( x , y ) = HGn ( x , y ) - HWn ( x , y )$$

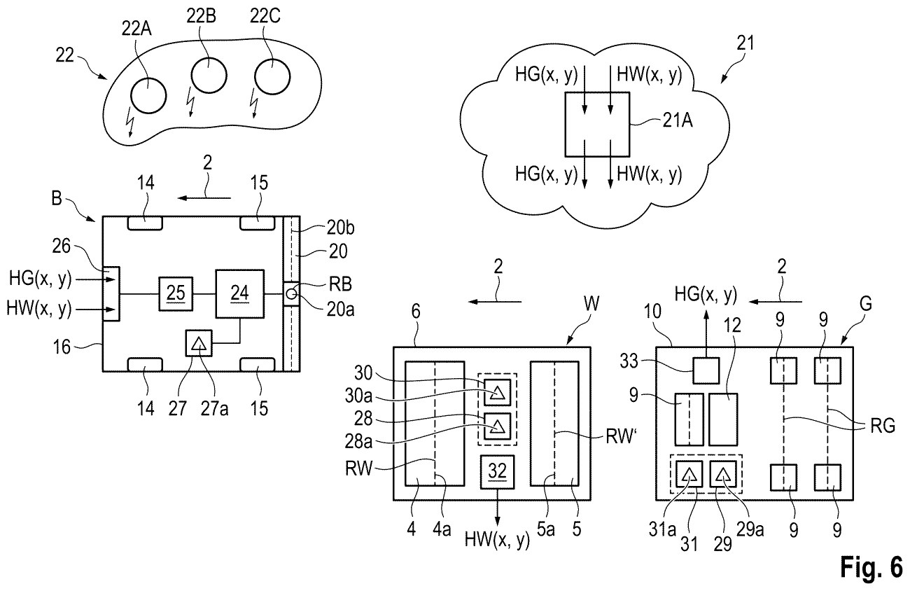

FIG. 6 illustrates a work process for determining the elevation HG(x, y) of the layer 8 applied to the compacted soil 3 with the grader G, and the elevation HW(x, y) of the soil 3 compacted with the road roller W in the terrain using the grader G and the road roller W itself. In FIG. 6, the road roller W with the machine frame 6 supported by the front roller drum 4 in the working direction 2 and the rear wheels 5, and the grader G with the machine frame supported by the front and rear wheels 9 and the blade 12 for distributing and leveling materials, are shown in a highly simplified manner.

The road roller W has a construction machine position determination device 28, which is configured to generate construction machine position data describing the position of a construction machine reference point RW assigned to the road roller, in the coordinate reference system (x, y), and the grader G has a construction machine position determination device 29, which is configured to generate construction machine position data describing the position of a construction machine reference point RG assigned to the grader, in the coordinate reference system (x, y). The construction machine position determination device 28 or 29 of the road roller W or grader G has a GNSS receiver 28a or 29a for receiving satellite signals from the global satellite navigation system 22. The construction machine position data describe the location where the construction machine is currently situated. The construction machine reference point RW (RW′) assigned to the road roller W is preferably located centrally on the axle 4a of the front roller drum 4 in the working direction 2 or on the axle 5a of the rear wheels 5 of the road roller.

Furthermore, the road roller W has an elevation position determination device 30, which is configured to generate elevation position data which in each case describe the position of an elevation reference point RHW in the coordinate reference system, which is located at the height of the contact surface of the front roller drum 4 or the rear wheels 5 on the ground 3 (FIGS. 1A and 1B). The elevation position determination device 30 of the road roller W has a GNSS receiver 30a for receiving satellite signals of the global satellite navigation system 20.

The grader G also has an elevation position determination device 31, which is designed to generate elevation position data which in each case describe the position of an elevation reference point RHG in the coordinate reference system, which is located at the height of the lower edge 12a of the movable blade 12 for distributing and leveling the soil (FIGS. 2A and 2B). The elevation position determination device 31 of the grader G has a GNSS receiver 31a for receiving satellite signals from the global satellite navigation system.

The construction machine position determination device 28 or 29 and the elevation position determination device 30 or 31 of the road roller W or grader G can form a common device, and the construction machine reference point RW or RG and the elevation reference point RHW or RHG can be a common reference point, so that with a single position determination device assigned to the road roller or grader, which has a GNSS receiver, the elevation of the compacted soil (road roller) or the elevation of the applied material layer (grader) (elevation information) at a specific point (x, y) in the terrain can be determined from the position data, in order to determine the position of a single reference point.

The binder spreader B involved in the work process is the binder spreader described with reference to FIG. 4 or 5, to which the layer thickness data set D1(x1, y1), D2(x2, y2), D3(x3, y3), . . . , Dn(xn, yn) (FIG. 4) or the first and second elevation profile data set HW1(x1, y1), HW2(x2, y2), HW3(x3, y3), . . . , HWn(xn, yn) or HG1(x1, y1), HG2(x2, y2), HG3(x3, y3), . . . , HGn(xn, yn) (FIG. 5) are provided.

During the advancement of the road roller W, the first elevation profile data of the first elevation profile data set HW1(x1, y1), HW2(x2, y2), HW3(x3, y3), . . . , HWn(xn, yn) are determined based on the elevation position data of the elevation position determination device 30 (elevation of the layer) and the construction machine position data of the construction machine position determination device 28 of the road roller W (position at which the elevation is measured), and during the distribution and leveling of the material layer 8 applied to the compacted soil 3, the second elevation profile data of the second elevation profile data set HG1(x1, y1), HG2(x2, y2), HG3(x3, y3), . . . , HGn(xn, yn) are determined based on the elevation position data of the elevation position determination device 31 and the construction machine position data of the construction machine position determination device 29 of the grader G, and the first and second elevation profile data sets are uploaded to the computer cloud 21. For this purpose, the road roller has an interface 32 and the grader G has an interface 33.

In the computer cloud 21, the layer thickness data set D1(x1, y1), D2(x2, y2), D3(x3, y3), . . . , Dn(xn, yn) can be generated on the basis of the elevation information of the elevation profile data of the first and second elevation profile data set by calculating the difference, and can be stored in the cloud storage 21A, so that the layer thickness data set can then be downloaded from the computer cloud 21 by the binder spreader B, as described with reference to FIG. 4. Alternatively, the first and second elevation profile data can be stored in the cloud storage device 21A and downloaded from the cloud storage device by the binder spreader B, the layer thickness data set being determined by the controller 24 of the binder spreader B from the first and second elevation profile data, as shown in FIG. 6. The binder spreader B then applies an amount of binder that depends on the thickness of the layer 8 applied to the compacted soil 3.

As an alternative to storing the elevation profile data sets in the cloud, the first elevation profile data set HW can be transferred directly from the interface 32 of the roller W to the interface 26 of the binder spreader B and thus made available to it for further processing.

Likewise, the second elevation profile data set HG can be transferred directly from the interface 33 of the grader G to the interface 26 of the binder spreader B and thus made available to it for further processing.

Consequently, during advancement of the road roller train W the elevation profile of the compacted soil is continuously plotted, and during the advancement of the grader G the elevation profile of the material layer 8 applied by the grader is continuously plotted. FIG. 3A to 3F show the different measured amounts of binder 13 in the region of the elevations 3a and depressions 3b. It is shown that in the region of elevations 3a the amount of binder is reduced and in the region of depressions 3b the amount of binder is reduced.

A layer thickness data set containing all layer thickness data does not need to be generated before the binder spreader B is started. When the binder spreader is started, the layer thickness data, which describe the layer thickness at the respective locations, can also be successively determined from the respective first and second elevation profile data, which describe the elevation of the terrain profiles at these locations, by calculating the difference.

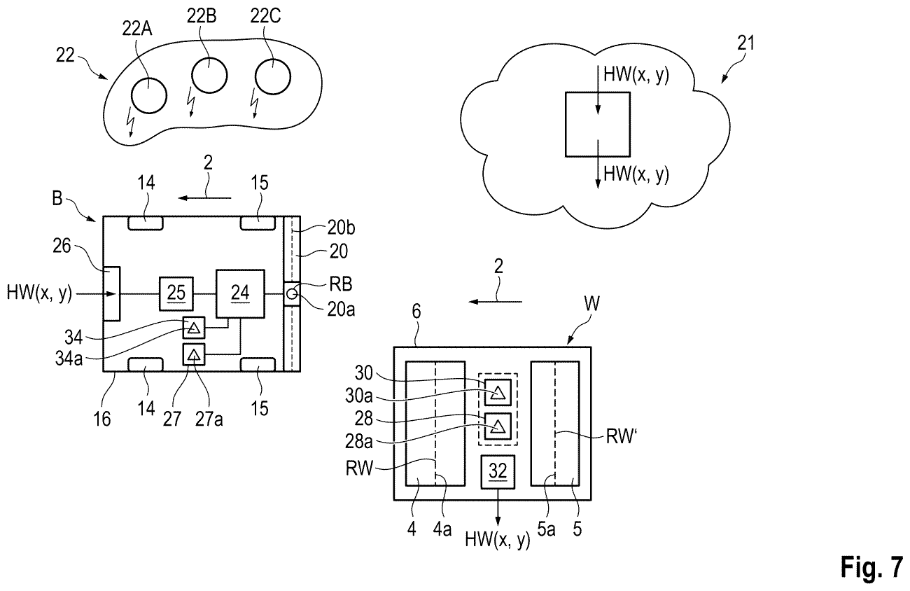

FIG. 7 illustrates an alternative work process in which the elevation profile data HB1(x1, y1), HB2(x2, y2), HB3(x3, y3), . . . , HBn(xn, yn) are not generated by the grader G, but rather by the binder spreader B itself. In FIG. 7, the binder spreader B, the computer cloud 21, the satellites 22A of the satellite navigation system 22 and the road roller W are shown in a highly simplified manner. The corresponding parts are again provided with the same reference signs.

As already described with reference to FIG. 5, the metering device 19 of the binder spreader B has a data storage device 25 for storing a first elevation profile data set HW1(x1, y1), HW2(x2, y2), HW3(x3, y3), . . . , HWn(xn, yn), which comprises elevation profile data that in each case describe the elevation of soil 3 compacted in the preceding operation with the road roller W, at a point in the terrain in the coordinate reference system, and which is downloaded from the computer cloud 21. Consequently, the elevation HW of the compacted soil 3 is known at the different points in the terrain. However, the second elevation profile data set HB1(x1, y1), HB2(x2, y2), HB3(x3, y3), . . . , HBn(xn, yn) does not need to be downloaded from the cloud to this data storage device 25, since the elevation profile data are generated by the metering device 19 itself.

In an alternative embodiment, the first elevation profile data set HW does not need to be downloaded from the cloud 21, but rather can be transferred directly from the roller W via its interface 32 to the interface 26 of the binder spreader B.

As already described with reference to FIGS. 4 and 5, the binder spreader B has a construction machine position determination device 27 which is designed to generate construction machine position data which in each case describe the position of a reference point RB assigned to the metering element 20, in the coordinate reference system. The construction machine position determination device 27 has a GNSS receiver 27a for receiving satellite signals of the global satellite navigation system 22. It is sufficient for the construction machine position data to describe the position of the reference point RB on the terrain surface. Elevation information is not required. In the present exemplary embodiment, the construction machine reference point RB is located at the outlet of the metering element 20, preferably centrally on the axis 20a extending transversely to the advancement direction of the binder spreader, along which the binder is applied by the metering element.

Furthermore, in the present exemplary embodiment, the binder spreader B has an elevation position determination device 34 which is configured to generate elevation position data which in each case describe the position of an elevation reference point RHB in the coordinate reference system, which is located at the height of the contact surface of the front or rear wheels 14, 15 on the soil (FIG. 3A). The elevation position determination device of the binder spreader B has a GNSS receiver 34a for receiving satellite signals from the global satellite navigation system 22.

The controller 24 of the binder spreader B generates the second elevation profile data HB1(x1, y1), HB2(x2, y2), HB3(x3, y3), . . . , HBn(xn, yn) on the basis of the elevation position data of the elevation position determination device 34 and the construction machine position data of the construction machine position determination device 27.

During the advancement of the binder spreader B, the second elevation profile data are determined on the basis of the elevation position data of the elevation position determination device 34 (elevation of the layer) and the construction machine position data of the construction machine position determination device 27 of the binder spreader B (position at which the elevation is measured). As described with reference to the previous figures, the layer thickness data D1(x1, y1), D2(x2, y2), D3(x3, y3), . . . , Dn(xn, yn) can be successively generated by the controller 24 on the basis of the elevation information of the previously determined first elevation profile data and the second elevation profile data. The controller 24 actuates the metering element 20 during the advancement of the binder spreader in such a way that a predetermined amount of binder is applied by the metering element depending on the layer thickness D of the applied material layer 8.

FIG. 8 shows a recycler or stabilizer in a simplified schematic representation. The construction machine has a machine frame 35 which is supported by a chassis 36. The chassis 36 has front and rear wheels 37, 38, which are fastened to front and rear lifting columns 39, 40. The front and rear lifting columns 39, 40 are in turn attached to the machine frame 35, so that the machine frame can be adjusted in height relative to the soil. Between the front and rear wheels 37, 38 there is a rotor housing 41 in which a milling/mixing rotor 42, shown only in outline, is arranged, which can be designed to be adjustable in milling depth relative to the rotor housing and thus to the machine frame. The stabilizer or recycler has a storage container 43 for a powdered binder, for example lime or cement, and a transport device 44 for applying the binder, for example a conveyor belt, and a metering device 45, for example a rotary valve. The binder is introduced into the soil immediately after milling, using the milling/mixing rotor 42.

Any of the data sets described above in the general form such as D1(x1, y1), D2(x2, y2), D3(x3, y3), . . . , Dn(xn, yn) may be described as a data set describing the vertical parameter (here D) at a plurality of points (x, y) in the terrain defined in the coordinate reference system independent of the relevant device. As these various data sets are described in the claims, they may be referred to as describing the vertical parameter at a “first” or “second” or “third” plurality of points, and it will be understood that this terminology is used only to distinguish between the referenced data sets. It is not required that the plurality of points described by each data set are the same points, although they may be.

1-16. (canceled)

17. An apparatus for applying binder for soil stabilization in a terrain, comprising:
a binder container for receiving binder; and
a metering device including a metering element, a controller and a data storage;
wherein the data storage is configured to store a layer thickness data set including layer thickness data describing a layer thickness of an applied material layer applied to a compacted soil at a plurality of points in the terrain defined in a coordinate reference system independent of the apparatus; and
wherein the controller is configured such that the layer thickness data of the layer thickness data set are read from the data storage and the metering element of the metering device is controlled during advancement of the apparatus such that depending on the layer thickness of the applied material layer a predetermined amount of binder is applied with the metering element.

18. The apparatus of claim 17, further comprising:
a construction machine position determination device configured to generate construction machine position data describing a position of a construction machine reference point associated with the apparatus in the coordinate reference system independent of the apparatus;
wherein the controller is configured such that based at least in part on the layer thickness data and the construction machine position data the layer thickness of the applied material layer is continuously determined and the metering element of the metering device is actuated during the advancement of the apparatus such that an amount of binder correlating to the layer thickness is applied with the metering element.

19. The apparatus of claim 17, wherein:
the metering device includes an interface configured to receive the layer thickness data set.

20. The apparatus of claim 19, wherein:
the interface is a cloud interface configured to read the layer thickness data set from a data storage device of a computer cloud.

21. An apparatus for applying binder for soil stabilization in a terrain, comprising:
a binder container for receiving binder; and
a metering device including a metering element, a controller and a data storage;
wherein the data storage is configured to store:
a first elevation profile data set including first elevation profile data describing an elevation of compacted soil compacted in a previous operation with a soil compaction device at a first plurality of points in the terrain defined in a coordinate reference system independent of the apparatus; and
a second elevation profile data set including second elevation profile data describing an elevation of a material layer applied to the compacted soil in an operation following the previous operation, with a material application device at a second plurality of points in the terrain defined in the coordinate reference system independent of the apparatus;
wherein the controller is configured such that the first and second elevation profile data sets are read out from the data storage, and layer thickness data are generated based at least in part on the first and second elevation profile data sets, the layer thickness data describing a layer thickness of the material layer applied to the compacted soil at a third plurality of points in the terrain defined in the coordinate reference system independent of the apparatus; and
wherein the controller is configured such that the metering element of the metering device is controlled during advancement of the apparatus such that depending on the layer thickness of the applied material layer a predetermined amount of binder is dispensed with the metering element.

22. The apparatus of claim 21, wherein:
the controller is configured such that the layer thickness data are generated based at least in part on a calculation of a difference between the elevation of the material layer applied to the compacted soil and the elevation of the compacted soil.

23. The apparatus of claim 21, further comprising:
a construction machine position determination device configured to generate construction machine position data describing a position of a construction machine reference point associated with the apparatus in the coordinate reference system independent of the apparatus;
wherein the controller is configured such that based at least in part on the layer thickness data and the construction machine position data the layer thickness of the applied material layer is continuously determined and the metering element of the metering device is actuated during the advancement of the apparatus such that an amount of binder correlating to the layer thickness is applied with the metering element.

24. The apparatus of claim 21, wherein:
the metering device includes an interface configured to receive the first and second elevation profile data sets.

25. The apparatus of claim 24, wherein:
the interface is a cloud interface configured to read the first and second elevation profile data sets from a data storage device of a computer cloud.

26. An apparatus for applying binder for soil stabilization in a terrain, comprising:
a binder container for receiving binder; and
a metering device including a metering element, a controller, an elevation position determination device and a data storage;
wherein the elevation position determination device is configured to generate elevation position data describing a position of an elevation reference point associated with the apparatus in a coordinate reference system independent of the apparatus;
wherein the data storage configured to store is a first elevation profile data set including first elevation profile data describing an elevation of compacted soil compacted in a previous operation with a soil compaction device at a first plurality of points in the terrain defined in the coordinate reference system independent of the apparatus;
wherein the controller is configured such that based at least in part on the elevation position data of the elevation position determination device, second elevation profile data are generated describing an elevation of a material layer applied to the compacted soil in an operation following the previous operation with a material application device at a second plurality of points in the coordinate reference system independent of the apparatus; and
the controller is further configured such that the first elevation profile data set is read out from the data storage, and layer thickness data are generated at least in part based on the first elevation profile data and the second elevation profile data describing a layer thickness of the material layer applied to the compacted soil at a third plurality of points in the coordinate reference system independent of the apparatus; and
wherein the controller is configured such that the metering element of the metering device is actuated during advancement of the apparatus such that depending on the layer thickness of the applied material layer a predetermined amount of binder is applied with the metering element.

27. The apparatus of claim 26, wherein:
the controller is configured such that the layer thickness data are generated based on a calculation of a difference between the elevation of the material layer applied to the compacted soil and the elevation of the compacted soil.

28. The apparatus of claim 26, further comprising:
a construction machine position determination device configured to generate construction machine position data describing a position of a construction machine reference point associated with the apparatus in the coordinate reference system independent of the apparatus;
wherein the controller is configured such that based at least in part on the layer thickness data and the construction machine position data the layer thickness of the applied material layer is continuously determined and the metering element of the metering device is actuated during the advancement of the apparatus such that an amount of binder corresponding to the layer thickness is applied with the metering element.

29. The apparatus of claim 28, wherein:
the construction machine position determination device and/or the elevation position determination device includes at least one GNSS receiver for receiving satellite signals from a global satellite system.

30. The apparatus of claim 26, wherein:
the metering device includes an interface configured to receive the first elevation profile data set.

31. The apparatus of claim 30, wherein:
the interface is a cloud interface configured to read the first elevation profile data set from a data storage device of a computer cloud.

32. A method of applying binder, comprising:
compacting a layer of compacted soil using a self-propelled device for compacting soil;
during the compacting, determining an elevation position of a reference point related to the self-propelled device for compacting soil, in a coordinate system;
applying to the compacted soil an uncompacted material layer using a self-propelled device for applying materials;
applying binder to the uncompacted material layer with a device for applying binder;
during the applying of the uncompacted material layer, determining an elevation position of a reference point related to the self-propelled device for applying materials, or during the applying binder to the uncompacted material layer determining an elevation position of a reference point related to the device for applying binder;
determining a layer thickness of the applied material layer from a difference in the elevation position of the reference point relating to the device for applying materials and the elevation position of the reference point relating to the device for compacting soil, or from a difference in the elevation position of the reference point relating to the device for applying binder and the reference point relating to the device for compacting soil;
during advancement of the device for applying binder, applying a predetermined amount of binder to the uncompacted material layer using a metering device provided on the device for applying binder, depending on the determined layer thickness of the applied material layer.

33. The method of claim 32, wherein:
the device for applying binder is a binder spreader or a soil stabilizer or a recycler, including a machine frame supported by wheels, and the reference point associated with the device for applying binder is located at a height of a contact surface of the wheels.

34. The method of claim 32, wherein:
the device for compacting soil is a roller train including a machine frame supported by wheels and a roller drum, and the reference point associated with the device for compacting soil is located at a height of a contact surface of the wheels or the roller drum.

35. The method of claim 32, wherein:
the device for applying materials is a grader including a machine frame supported by wheels, on which a blade for distributing and leveling materials is provided, and the reference point associated with the device for applying materials is located at a height of a lower edge of the blade.
